(19) United States
(12) Patent Application Publication
(10) Pub. No.: US 2014/0062409 A1
(43) Pub. Date: Mar. 6, 2014

(54) POWER SUPPLY SYSTEM

(71) Applicants: Hiroki ENDO, Nisshin-shi (JP); Itaru SETA, Shinjuku-ku (JP)

(72) Inventors: Hiroki ENDO, Nisshin-shi (JP); Itaru SETA, Shinjuku-ku (JP)

(73) Assignees: FUJI JUKOGYO KABUSHIKI KAISHA, Shinjuku-ku (JP); TOYOTA JIDOSHA KABUSHIKI KAISHA, Toyota-shi (JP)

(21) Appl. No.: 13/974,552

(22) Filed: Aug. 23, 2013

(30) Foreign Application Priority Data
Aug. 29, 2012 (JP) 2012-188676

(51) Int. Cl. H02J 7/00

(52) U.S. Cl. CPC H02J 7/0029; H02J 7/0063
USPC 320/126

(57) ABSTRACT

In control over a power supply system that includes a plurality of parallel connected batteries, electric power is supplied from the plurality of batteries to an electrical device at a total output upper limit value that is obtained by applying a first computing to individual output upper limit values of the plurality of batteries, and, when there is an abnormality in at least one of the plurality of batteries, the at least one of the plurality of batteries, having an abnormality, is isolated, and a total output upper limit value is set by applying a second computing to the battery having no abnormality, the total output upper limit value being smaller than the total output upper limit value obtained through the first computing.

### INCORPORATION BY REFERENCE

The disclosure of Japanese Patent Application No. 2012-188676 filed on Aug. 29, 2012 including the specification, drawings and abstract is incorporated herein by reference in its entirety.

### BACKGROUND OF THE INVENTION

1. Field of the Invention

The invention relates to a power supply system and, more particularly, to a power supply system that includes a plurality of parallel connected batteries and that supplies electric power from the plurality of batteries to an electrical device at a total output upper limit value that is obtained by applying a first computing to individual output upper limit values of the plurality of batteries.

2. Description of Related Art

There is suggested a power supply system of this type, in which, when there occurs an abnormality in one of two parallel connected batteries, the battery having an abnormality is isolated by opening a system main relay connected to the battery having an abnormality (for example, see Japanese Patent Application Publication No. 2012-138278 (JP 2012-138278 A)). In this power supply system, at the time of isolating the battery having an abnormality, a system request power is temporarily limited to a value “0” in order to prevent spark at the time of opening the system main relay, and, after the battery having an abnormality has been isolated, the system request power is limited by an upper limit value.

There is also suggested an electromotive vehicle in which, when there occurs an abnormality in at least any one of a plurality of parallel connected battery modules, an output upper limit value is calculated on the basis of the battery modules having no abnormality and the battery module having an abnormality is isolated at the time when the calculated output upper limit value is higher than or equal to a predetermined value (For example, see Japanese Patent Application Publication No. 2010-273417 (JP 2010-273417 A)). In this electromotive vehicle, it is possible to continue safety travel with the use of the normal battery modules by executing the above-described control.

### SUMMARY OF THE INVENTION

In the power supply system described in JP 2012-138278 A, or the like, the system request power is limited by the upper limit value; however, when the system request power at the upper limit value is output from the batteries having no abnormality, the batteries degrade depending on the state of the batteries having no abnormality. In addition, in the above-described electromotive vehicle, the output upper limit value that is calculated on the basis of the batteries having no abnormality is used; however, after the battery having an abnormality has been isolated, a request power is easily limited by the output upper limit value and a discharge at the output upper limit value is easily carried out, so degradation of the batteries tends to occur.

The invention provides a power supply system that, when there is an abnormality in at least any one of a plurality of parallel connected batteries, suppresses degradation of the battery having no abnormality while supply of electric power from the battery having no abnormality to an electrical device is maintained.

A first aspect of the invention provides a power supply system that includes a plurality of batteries and a controller. The plurality of batteries are connected in parallel. The controller is configured to supply electric power from the plurality of batteries to an electrical device at a total output upper limit value that is obtained by applying a first computing to individual output upper limit values of the plurality of batteries. The controller is configured to, when there is an abnormality in at least one of the plurality of batteries, isolate the at least one of the plurality of batteries and to set a total output upper limit value by applying a second computing to the battery having no abnormality, and the total output upper limit value obtained through the second computing being smaller than the total output upper limit value obtained through the first computing.

With the power supply system according to the invention, during normal times in which there is no abnormality in any of the plurality of batteries, electric power is supplied from the plurality of batteries to the electrical device at a total output upper limit value that is obtained through the first computing, and, during abnormal times in which there is an abnormality in at least one of the plurality of batteries, the at least one of the plurality of batteries, having an abnormality, is isolated, and a total output upper limit value is set by applying the second computing to the battery having no abnormality, the total output upper limit value being smaller than the total output upper limit value obtained through the first computing. That is, during abnormal times, the total output upper limit value that is obtained through the second computing and that is smaller than the total output upper limit value obtained through the first computing during normal times is used. Thus, the total output upper limit value of the battery having no abnormality is small, so it is possible to suppress degradation of the battery having no abnormality. Of course, it is possible to supply electric power from the battery having no abnormality to the electrical device.

In the power supply system, the second computing may be a computing of obtaining the total output upper limit value by multiplying the total output upper limit value obtained through the first computing by a coefficient larger than 0 and smaller than 1. Thus, it is possible to obtain the total output upper limit value during abnormal times only by multiplying the total output upper limit value, obtained through the first computing during normal times, by the coefficient.

In the power supply system, the first computing may be a computing of obtaining the total output upper limit value through summation of the individual output upper limit values or a computing of obtaining the total output upper limit value by multiplying a minimum value among the individual output upper limit values by the number of the batteries.

In the power supply system, the controller may be configured to, when there is no abnormality in any of the plurality of batteries, set a total input upper limit value that is obtained by applying a third computing to individual input upper limit values of the plurality of batteries, and the controller may be configured to, when there is an abnormality in at least one of the plurality of batteries, set a total input upper limit value by applying a fourth computing to the battery having no abnormality, and the total input upper limit value obtained through the fourth computing being smaller than the total input upper limit value obtained through the third computing. That is, during normal times in which there is no abnormality in any of the plurality of batteries, charging is carried out using electric power from the electrical device at a total input upper limit value that is obtained by applying the third computing to the individual input upper limit values of the plurality of batteries; whereas, during abnormal times in which there is an abnormality in at least one of the plurality of batteries, charging is carried out using electric power from the electrical device at a total input upper limit value by applying the fourth computing to the battery having no abnormality, the total input upper limit value being smaller than the total input upper limit value obtained through the third computing. Thus, the total input upper limit value of the battery having no abnormality is small, so it is possible to suppress degradation of the battery having no abnormality. Of course, it is possible to maintain charging of the battery having no abnormality using electric power from the electrical device.

In the power supply system, the third computing may be a computing of obtaining the total input upper limit value through summation of the individual input upper limit values or a computing of obtaining the total input upper limit value by multiplying a minimum value among the individual input upper limit values by the number of the batteries, and the fourth computing may be a computing of obtaining the total input upper limit value by multiplying the total input upper limit value obtained through the third computing by a coefficient larger than 0 and smaller than 1. Thus, it is possible to obtain the total input upper limit value during abnormal times only by multiplying the total input upper limit value, obtained through the third computing during normal times, by the coefficient.

A second aspect of the invention provides a control method for a power supply system that includes a plurality of parallel connected batteries. The control method includes: supplying electric power from the plurality of batteries to an electrical device at a total output upper limit value that is obtained by applying a first computing to individual output upper limit values of the plurality of batteries; and, when there is an abnormality in at least one of the plurality of batteries, isolating the at least one of the plurality of batteries and setting a total' output upper limit value by applying a second computing to the battery having no abnormality, the total output upper limit value being smaller than the total output upper limit value obtained through the first computing.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration view that schematically shows the configuration of an electric vehicle on which a power supply system according to an embodiment of the invention is mounted;

FIG. 2 is a flowchart that shows an example of an input/output upper limit value setting routine that is executed by an electronic control unit; and

FIG. 3 is a flowchart that shows an example of an input/output upper limit value setting routine according to an alternative embodiment.

### DETAILED DESCRIPTION OF EMBODIMENTS

An embodiment of the invention will be described.

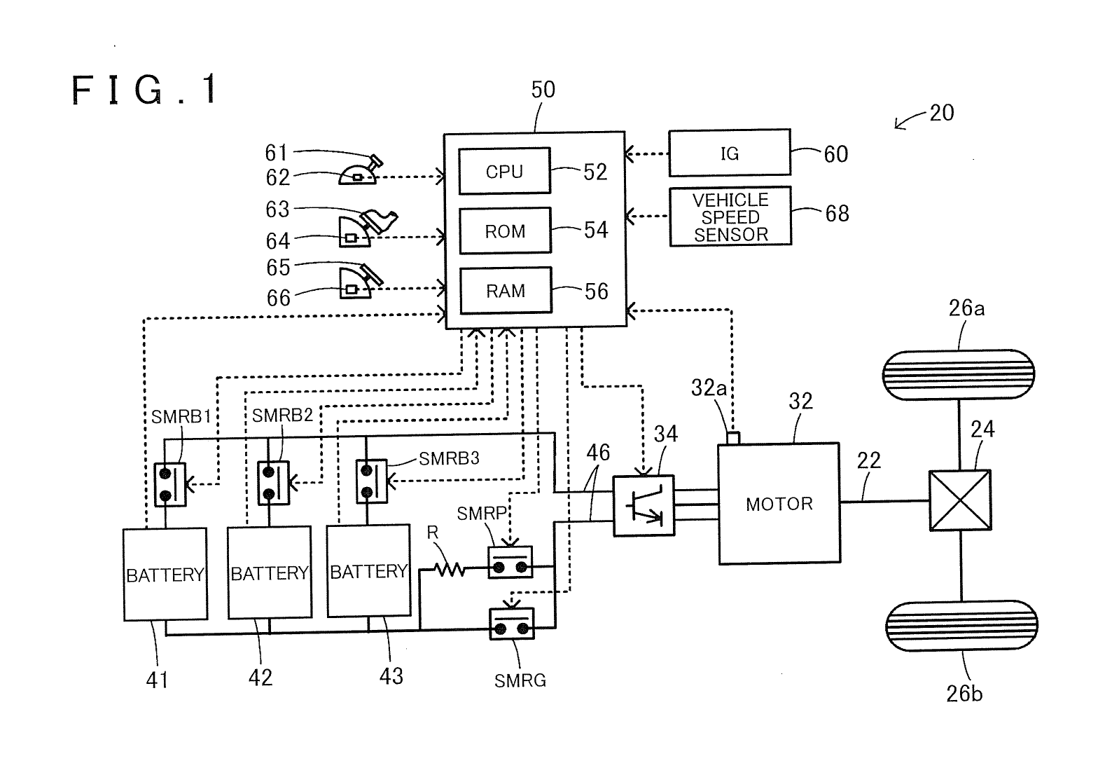

FIG. 1 is a configuration view that schematically shows the configuration of an electric vehicle 20 on which a power supply system according to the embodiment of the invention is mounted. As shown in the drawing, the electric vehicle 20 according to the embodiment includes a motor 32, an inverter 34, three batteries 41 to 43, a system main relay SMR and an electronic control unit 50. The motor 32 is, for example, formed of a synchronous motor generator, and is able to input or output power to or from a drive shaft 22 connected to drive wheels 26a, 26b via a differential gear 24. The inverter 34 is used to drive the motor 32. The three batteries 41 to 43 are, for example, formed of lithium ion batteries, and are connected in parallel with one another. The system main relay SMR is connected to power lines 46 from the three batteries 41. The electronic control unit 50 comprehensively controls the vehicle. Here, the power supply system includes the three batteries 41 to 43, the system main relay SMR and the electronic control unit 50.

The motor 32 is formed as a known synchronous motor generator that includes a rotor in which permanent magnets are embedded and a stator in which three-phase coils are wound. Although not shown in the drawing, the inverter 34 is formed of a known inverter that is formed of six transistors T11 to T16 that serve as switching elements and six diodes that are respectively antiparallel connected to the six transistors T11 to T16.

The system main relay SMR is formed of three positive electrode-side relays SMRB1, SMRB2, SMRB3, a negative electrode-side relay SMRG, and a pre-charge circuit. The positive electrode-side relays SMRB1, SMRB2, SMRB3 are connected to the positive electrode terminal sides of the three batteries 41 to 43. The negative electrode-side relay SMRG is connected to a negative electrode terminal-side bus that is common to the three batteries 41 to 43. The pre-charge circuit is formed of a pre-charge resistor R and a pre-charge relay SMRP, and is connected so as to bypass the negative electrode-side relay SMRG.

The electronic control unit 50 is formed of a microprocessor that mainly includes a CPU 52. The electronic control unit 50, in addition to the CPU 52, includes a ROM 54 that stores processing programs, a RAM 56 that temporarily stores data, and input/output ports (not shown). For example, a rotational position of the rotor of the motor 32 from a rotational position detection sensor 32a, phase currents from current sensors (not shown), terminal voltages Vb1, Vb2, Vb3 from voltage sensors (not shown), charge/discharge currents Ib1, Ib2, Ib3 from current sensors (not shown), battery temperatures Tb1, Tb2, Tb3 from temperature sensors (not shown), a voltage Yb from a voltage sensor (not shown), an ignition signal from an ignition switch 60, a shift position SP from a shift position sensor 62, an accelerator operation amount Acc from an accelerator pedal position sensor 64, a brake pedal position BP from a brake pedal position sensor 66, and a vehicle speed V from a vehicle speed sensor 68 are input to the electronic control unit 50 via the input port. The rotational position detection sensor 32a detects the rotational position of the rotor of the motor 32. The current sensors (not shown) are connected to connection lines (power lines) between the motor 32 and the inverter 34. The voltage sensors (not shown) are respectively installed between the pairs of terminals of the three batteries 41, 42, 43. The current sensors (not shown) are connected to the output terminals of the three batteries 41, 42, 43. The temperature sensors (not shown) are respectively attached to the three batteries 41, 42, 43. The voltage sensor (not shown) is connected to the power lines 46. The shift position sensor 62 detects the operating position of a shift lever 61. The accelerator pedal position sensor 64 detects the depression amount of an accelerator pedal 63. The brake pedal position sensor 66 detects the depression amount of a brake pedal 65. For example, switching control signals to the six transistors of the inverter 34 and driving signals to the relays SMRB1, SMRB2, SMRB3, SMRG, SMRP that constitute the system main relay SMR are output from the electronic control unit 50 via the output port.

The electronic control unit 50 executes the process of computing a rotation speed Nm of the motor 32 on the basis of the rotational position of the rotor of the motor 32 from the rotational position detection sensor 32a, computing states of charge SOC1, SOC2, SOC3 of the batteries 41, 42, 43 on the basis of accumulated values of the charge/discharge currents Ib1, Ib2, Ib3 detected by the current sensors in order to manage the three batteries 41, 42, 43, computing individual output upper limit values Wout1, Wout2, Wout3 that are maximum allowable electric powers allowed to be discharged from the batteries 41, 42, 43 on the basis of the computed states of charge SOC1, SOC2, SOC3 and the battery temperatures Tb1, Tb2, Tb3 and individual input upper limit values Win1, Win2, Win3 that are chargeable maximum allowable electric powers, and storing the computed individual output upper limit values Wout1, Wout2, Wout3 and the computed individual input upper limit values Win1, Win2, Win3 in a predetermined area of the RAM 56. It is possible to compute the output upper limit values Wout1, Wout2, Wout3 of the respective batteries 41, 42, 43 as follows. Basic output upper limit values Woutf1, Woutf2, Woutf3 are set on the basis of the battery temperatures Tb1, Tb2, Tb3. Output upper limit correction coefficients are respectively set on the basis of the states of charge SOC1, SOC2, SOC3 of the respective batteries 41, 42, 43. The set basic output upper limit values Woutf1, Woutf2, Woutf3 are respectively multiplied by the set output upper limit correction coefficients. In addition, it is possible to compute the input upper limit values Win1, Win2, Win3 of the respective batteries 41, 42, 43 as follows. Basic input upper limit values Winf1, Winf2, Winf3 are set on the basis of the battery temperatures Tb1, Tb2, Tb3. Input upper limit correction coefficients are respectively set on the basis of the states of charge SOC1, SOC2, SOC3 of the respective batteries 41, 42, 43. The set basic input upper limit values Winf1, Winf2, Winf3 are respectively multiplied by the set input upper limit correction coefficients.

The thus configured electric vehicle 20 according to the embodiment is subjected to drive control through a drive control routine (not shown). In drive control, the transistors of the inverter 34 are subjected to switching control as follows. A request torque Tr* that should be output to the drive shaft 22 is set on the basis of the accelerator operation amount Acc from the accelerator pedal position sensor 64 and the vehicle speed V from the vehicle speed sensor 68. A torque command Tm* that should be output from the motor 32 is set by limiting the set request torque Tr* with the use of a total output upper limit value Wout, which is computed as the sum of the output upper limit values Wout1, Wout2, Wout3 of the respective batteries 41, 42, 43 and a total input upper limit value Win, which is computed as the sum of the input upper limit values Win1, Win2, Win3 of the respective batteries 41, 42, 43. The switching control of the transistor of the inverter 34 is executed so that the motor 32 is driven at the set torque command Tm*. Setting of the torque command Tm* of the motor 32 is specifically carried out by setting a value, obtained by dividing the total output upper limit value Wout by the rotation speed Nm of the motor 32, as an upper limit value when the request torque Tr* is set for power running (driving force) and setting a value, obtained by dividing the total input upper limit value Win by the rotation speed Nm of the motor 32, as an upper limit value (upper limit value as an absolute value) when the request torque Tr* is set for regeneration (braking force).

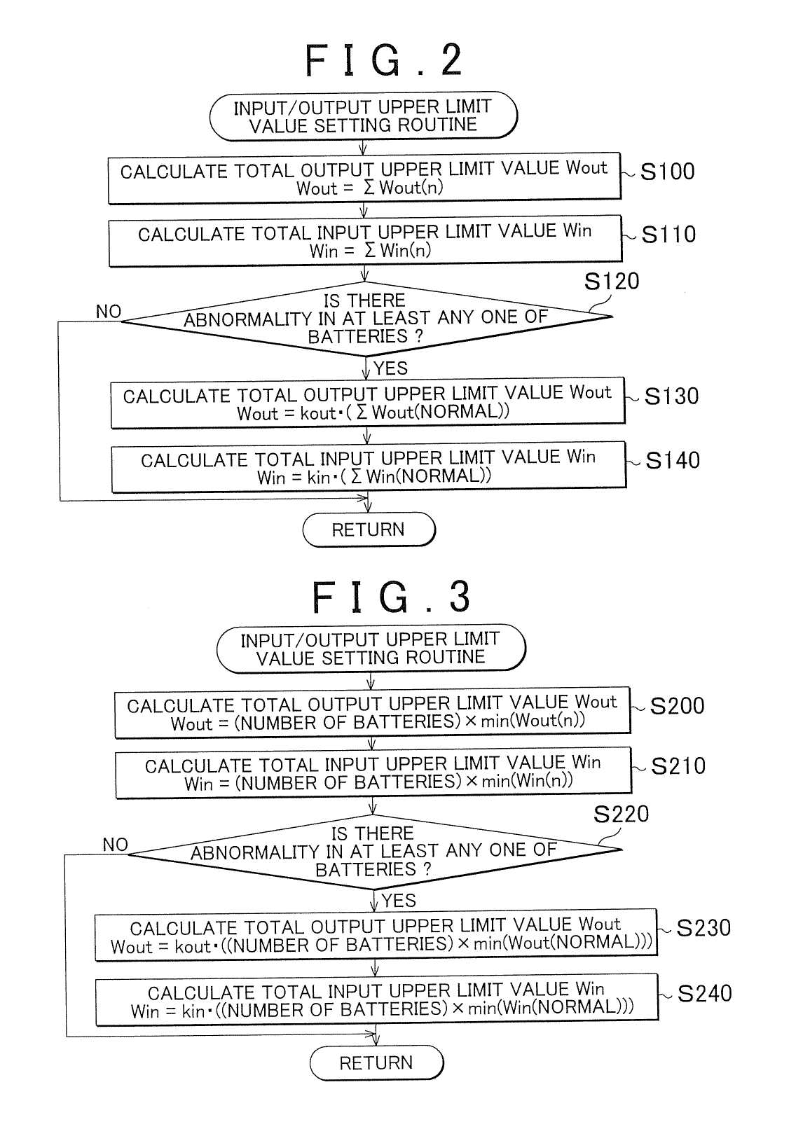

Next, the operation of the power supply system mounted on the electric vehicle 20 according to the embodiment, particularly, the operation at the time of setting the total output upper limit value Wout and the total input upper limit value Win when there is an abnormality in at least any one of the three batteries 41, 42, 43, will be described. FIG. 2 is a flowchart that shows an example of an input/output upper limit value setting routine that is executed by the electronic control unit 50. The routine is repeatedly executed at predetermined intervals (for example, at intervals of several tens of milliseconds, or the like). When there is an abnormality in at least any one of the batteries 41, 42, 43, the battery having an abnormality is isolated by opening the positive electrode-side relay of the battery having an abnormality. For example, when the battery 42 has an abnormality, the positive electrode-side relay SMRB2 is turned off (opened) and then the battery 42 is isolated, and, when the battery 41 and the battery 42 have an abnormality, the corresponding positive electrode-side relays SMRB1, SMRB2 are turned off (opened) and then the batteries 41, 42 having an abnormality are isolated.

When the input/output upper limit value setting routine is executed, the CPU 52 of the electronic control unit 50 initially calculates the total output upper limit value Wout through summation of the individual output upper limit values Wout1, Wout2, Wout3 of the respective batteries 41, 42, 43 (step S100), calculates the total input upper limit value Win through summation of the individual input upper limit values Win1, Win2, Win3 of the respective batteries 41, 42, 43 (step S110), and then determines whether there is an abnormality in at least any one of the three batteries 41, 42, 43 (step S120). Here, the individual output upper limit values Wout1, Wout2, Wout3 and individual input upper limit values Win1, Win2, Win3 of the batteries 41, 42, 43 are those computed on the basis of the battery temperatures Tb1, Tb2, Tb3 and the states of charge SOC1, SOC2, SOC3 based on the accumulated values of the charge/discharge currents Ib1, Ib2, Ib3 of the respective batteries 41, 42, 43, and stored in the predetermined area of the RAM 56. These individual output upper limit values Wout1, Wout2, Wout3 and individual input upper limit values Win1, Win2, Win3 are loaded and used here. It is possible to determine whether there is an abnormality in at least any one of the three batteries 41, 42, 43 by checking the values of abnormality determination flags F1, F2, F3 that are set through an abnormality determination routine (not shown) in which, when there is no abnormality in at least any one of the batteries 41, 42, 43, values “0” are held in corresponding abnormality determination flags F1, F2, F3 and, when there is an abnormality in at least any one of them, a value “1” is set for the corresponding abnormality flag F1, abnormality flag F2 or abnormality flag F3. Abnormality determination as to each of the batteries 41, 42, 43 may be, for example, made by determining whether the voltage falls within an allowable voltage range, determining whether the current falls within an allowable current range, determining whether the temperature falls within an allowable temperature range, determining whether the internal resistance falls within an allowable range, or the like. When there is no abnormality in any of the batteries 41, 42, 43, that is, when the batteries 41, 42, 43 are normal, the routine is ended without correcting the set total output upper limit value Wout or the set total input upper limit value Win. Thus, when the batteries 41, 42, 43 are normal, the request torque Tr* is limited by the total output upper limit value Wout based on the sum of the individual output upper limit values Wout1, Wout2, Wout3 of the respective batteries 41, 42, 43 and the total input upper limit value Win based on the sum of the individual input upper limit values Win1, Win2, Win3 of the respective batteries 41, 42, 43, the torque command Tm* of the motor 32 is set, and then the motor 32 is subjected to drive control.

On the other hand, when it is determined in step S120 that there is an abnormality in at least any one of the batteries 41, 42, 43, the total output upper limit value Wout is calculated by multiplying the sum of the individual output upper limit values Wout(n) of the batteries having no abnormality, that is, the normal batteries, by a correction coefficient kout larger than value “0” and smaller than value “1” (step S130), the total input upper limit value Win is calculated by multiplying the sum of the individual input upper limit values Win(n) of the normal batteries by a correction coefficient kin larger than value “0” and smaller than value “1” (step S140), and the routine is ended. For example, when there is an abnormality in the battery 42, the total output upper limit value Wout is calculated by multiplying the sum of the individual output upper limit values Wout1, Wout3 of the batteries 41, 43 by the correction coefficient kout, and the total input upper limit value Win is calculated by multiplying the sum of the individual input upper limit values Win1, Win3 of the batteries 41, 43 by the correction coefficient kin. In addition, when there is an abnormality in the two batteries 41, 42, the total output upper limit value Wout is calculated by multiplying the individual output upper limit value Wout3 of the battery 43 by the correction coefficient kout, and the total input upper limit value Win is calculated by multiplying the individual input upper limit value Win3 of the battery 43 by the correction coefficient kin. Thus, when there is an abnormality in at least any one of the batteries 41, 42, 43, the request torque Tr* is limited by the total output upper limit value Wout that is obtained by multiplying the sum of the individual output upper limit values Wout(n) of the normal batteries by the correction coefficient kout and the total input upper limit value Win that is obtained by multiplying the sum of the individual input tipper limit values Win(n) by the correction coefficient kin, the torque command Tm* of the motor 32 is set, and then the motor 32 is subjected to drive control. Here, a value larger than value “0” and smaller than value “1” is used as the correction coefficient kout and the correction coefficient kin in order to reduce the total output upper limit value and the total input upper limit value for the batteries having no abnormality during abnormal times in which there is an abnormality in at least any one of the batteries 41, 42, 43 in comparison with the total output upper limit value and the total input upper limit value that are obtained through a calculation method during normal times in which there is no abnormality in any of the batteries 41, 42, 43. In this way, during abnormal times, by reducing the total output upper limit value and the total input upper limit value as compared with those obtained through the calculation method during normal times, limitations on charging and discharging of the batteries having no abnormality are enhanced, and facilitation of degradation of the batteries having no abnormality is suppressed.

With the above-described power supply system that is mounted on the electric vehicle 20 according to the embodiment, when there is an abnormality in at least any one of the batteries 41, 42, 43, the total output upper limit value Wout is calculated by multiplying the sum of the individual output upper limit values Wout(n) of the batteries having no abnormality by the correction coefficient kout larger than value “0” and smaller than value “1”, the total input upper limit value Win is calculated by multiplying the sum of the individual input upper limit values Win(n) of the batteries having no abnormality by the correction coefficient kin larger than value “0” and smaller than value “1”, the request torque Tr* is limited using the calculated total output upper limit value Wout and the calculated total input upper limit value Win, the torque command Tm* of the motor 32 is set and then the motor 32 is driven. Thus, it is possible to suppress facilitation of degradation of the batteries having no abnormality while the motor 32 is continuously driven.

The power supply system that is mounted on the electric vehicle 20 according to the embodiment includes the three parallel connected batteries 41, 42, 43; instead, the power supply system may include four or more parallel connected batteries or two parallel connected batteries.

In the power supply system that is mounted on the electric vehicle 20 according to the embodiment, when there is no abnormality in any of the batteries 41, 42, 43, the total output upper limit value Wout is calculated through summation of the individual output upper limit values Wout1, Wout2, Wout3 and the total input upper limit value Win is calculated through summation of the individual input upper limit values Win1, Win2, Win3; whereas, when there is an abnormality in at least any one of the batteries 41, 42, 43, the total output upper limit value Wout is calculated by multiplying the sum of the individual output upper limit values Wout(n) of the batteries having no abnormality by the correction coefficient kout and the total input upper limit value Win is calculated by multiplying the sum of the individual input upper limit values Win(n) of the batteries having no abnormality by the correction coefficient kin. Instead, the total output upper limit value Wout and the total input upper limit value Win may be calculated through another method. For example, the total output upper limit value Wout may be calculated by using the minimum value among the individual output upper limit values Wout1, Wout2, Wout3, and the total input upper limit value Win may be calculated by using the minimum value among the individual input upper limit values Win1, Win2, Win3. An input/output upper limit value setting routine in this case is shown in FIG. 3. In this routine, initially, the total output upper limit value Wout is calculated by multiplying the minimum output upper limit value among the individual output upper limit values Wout1, Wout2, Wout3 by the number of the batteries (step S200), the total input upper limit value Win is calculated by multiplying the minimum input upper limit value among the individual input upper limit values Win1, Win2, Win3 by the number of the batteries (step S210), and it is determined whether there is an abnormality in at least any one of the three batteries 41, 42, 43 (step S220). When there is no abnormality in any of the batteries 41, 42, 43, the routine is ended; whereas, when there is an abnormality in at least any one of the batteries 41, 42, 43, the total output upper limit value Wout is calculated by multiplying the correction coefficient kout by a value that is obtained by multiplying the minimum output upper limit value among the individual output upper limit values Wout(n) of the batteries having no abnormality by the number of the batteries having no abnormality (step S230), and the total input upper limit value Win is calculated by multiplying the correction coefficient kin by a value that is obtained by multiplying the minimum input upper limit value among the individual input upper limit values Win(n) of the batteries having no abnormality by the number of the batteries having no abnormality (step S240), after which the routine is ended. In this case as well, during abnormal times in which there is an abnormality in at least any one of the batteries 41, 42, 43, it is possible to reduce the total output upper limit value and the total input upper limit value as compared with those obtained through the calculation method during normal times in which there is no abnormality in any of the batteries 41, 42, 43, so it is possible to suppress facilitation of degradation of the batteries having no abnormality while the motor 32 is continuously driven.

The power supply system according to the embodiment is mounted on the electric vehicle 20; instead, the power supply system may be mounted on a vehicle, other than the electric vehicle, or a mobile unit, such as a ship and an air plane, or may be assembled to equipment, or the like, that is not a mobile unit, such as construction equipment.

The correspondence relationship between major elements of the above-described embodiment and major elements of the invention described in Summary of the Invention will be described. In the embodiment, the batteries 41, 42, 43 may be regarded as “the plurality of parallel connected batteries”. When there is no abnormality in any of the batteries 41, 42, 43, the method of calculating the total output upper limit value Wout through summation of the individual output upper limit values Wout1, Wout2, Wout3 or the method of calculating the total output upper limit value Wout by multiplying the minimum output upper limit value among the individual output upper limit values Wout1, Wout2, Wout3 by the number of the batteries may be regarded as “the first method (i.e., the first calculation or computing)”. When there is an abnormality in at least any one of the batteries 41, 42, 43, the method of calculating the total output upper limit value Wout by multiplying the sum of the individual output upper limit values Wout(n) of the batteries having no abnormality among the batteries 41, 42, 43 by the correction coefficient kout larger than value “0” and smaller than value “1” or the method of calculating the total output upper limit value Wout by multiplying the correction coefficient kout by a value that is obtained by multiplying the minimum output upper limit value among the individual output upper limit values Wout(n) of the batteries having no abnormality by the number of the batteries having no abnormality may be regarded as “the second method (i.e., the second calculation or computing)”. In addition, when there is no abnormality in any of the batteries 41, 42, 43, the method of calculating the total input upper limit value Win through summation of the individual input upper limit values Win1, Win2, Win3 or the method of calculating the total input upper limit value Win by multiplying the minimum input upper limit value among the individual input upper limit values Win1, Win2, Win3 by the number of the batteries may be regarded as “the third method (i.e., the third calculation or computing)”. When there is an abnormality in at least any one of the batteries 41, 42, 43, the method of calculating the total input upper limit value Win by multiplying the sum of the individual input upper limit values Win(n) of the batteries having no abnormality among the batteries 41, 42, 43 by the correction coefficient kin larger than value “0” and smaller than value “1” or the method of calculating the total input upper limit value Win by multiplying the correction coefficient kin by a value that is obtained by multiplying the minimum input upper limit value among the individual input upper limit values Win(n) of the batteries having no abnormality by the number of the batteries having no abnormality may be regarded as “the fourth method (i.e., the fourth calculation or computing)”.

The correspondence relationship between major components of the embodiment and major components of the invention described in Summary of the Invention does not limit the components of the invention described in Summary of the Invention because the embodiment is an example for specifically illustrating a mode for carrying out the invention described in Summary of the Invention. That is, interpretation of the invention described in Summary of the Invention should be made on the basis of the description therein, and the embodiment is just a specific example of the invention described in Summary of the Invention.

The mode for carrying out the invention is described using the embodiment; however, the invention is not limited to the above embodiment, and, of course, various modifications are applicable without departing from the scope of the invention.

The invention is usable in, for example, manufacturing industry of a power supply system.

What is claimed is:

1. A power supply system comprising:
a plurality of parallel connected batteries; and
a controller configured to supply electric power from the plurality of batteries to an electrical device at a total output upper limit value that is obtained by applying a first computing to individual output upper limit values of the plurality of batteries, the controller being configured to, when there is an abnormality in at least one of the plurality of batteries, isolate the at least one of the plurality of batteries and to set a total output upper limit value by applying a second computing to the battery having no abnormality, and the total output upper limit value obtained through the second computing being smaller than the total output upper limit value obtained through the first computing.

2. The power supply system according to claim 1, wherein
the second computing is a computing of obtaining the total output upper limit value by multiplying the total output upper limit value obtained through the first computing by a coefficient larger than 0 and smaller than 1.

3. The power supply system according to claim 1, wherein
the first computing is a computing of obtaining the total output upper limit value through summation of the individual output upper limit values or a computing of obtaining the total output upper limit value by multiplying a minimum value among the individual output upper limit values by the number of the batteries.

4. The power supply system according to claim 1, wherein
the controller is configured to, when there is no abnormality in any of the plurality of batteries, set a total input upper limit value that is obtained by applying a third computing to individual input upper limit values of the plurality of batteries, the controller is configured to, when there is an abnormality in at least one of the plurality of batteries, set a total input upper limit value by applying a fourth computing to the battery having no abnormality, and
the total input upper limit value obtained through the fourth computing being smaller than the total input upper limit value obtained through the third computing.

5. The power supply system according to claim 4, wherein
the third computing is a computing of obtaining the total input upper limit value through summation of the individual input upper limit values or a computing of obtaining the total input upper limit value by multiplying a minimum value among the individual input upper limit values by the number of the batteries, and
the fourth computing is a computing of obtaining the total input upper limit value by multiplying the total input upper limit value obtained through the third computing by a coefficient larger than 0 and smaller than 1.

6. A control method for a power supply system that includes a plurality of parallel connected batteries, comprising:
supplying electric power from the plurality of batteries to an electrical device at a total output upper limit value that is obtained by applying a first computing to individual output upper limit values of the plurality of batteries; and
when there is an abnormality in at least one of the plurality of batteries, isolating the at least one of the plurality of batteries and setting a total output upper limit value by applying a second computing to the battery having no abnormality, the total output upper limit value being smaller than the total output upper limit value obtained through the first computing.
